(19) United States
(12) Patent Application Publication
(10) Pub. No.: US 2011/0219456 A1
(43) Pub. Date: Sep. 8, 2011

(54) WEBLOG FOR SUPPLY CHAIN MANAGEMENT

(76) Inventors: JAYARAM SRINIVASAN, Bangalore (IN); Nageshwara Manda, Hyderabad (IN)

(21) Appl. No.: 12/947,000

(22) Filed: Nov. 16, 2010

(30) Foreign Application Priority Data
Mar. 8, 2010 (IN) 605/CHE/2010

(51) Int. Cl. G06F 21/00

(52) U.S. Cl. 726/26

(57) ABSTRACT

Disclosed are methods and systems for accessing a supply chain process through a weblog. The methods and systems involves receiving data from a one or more machines associated with a supply chain process, the supply chain process comprising a plurality of data publishing stages, updating the weblog with the data received from each of the data publishing stage of the one or more machines, retrieving access rights for accessing the data updated to the weblog and displaying the data in the weblog based on the access rights.

### CROSS REFERENCE TO RELATED APPLICATIONS

This application claims the benefit of and priority to Indian Provisional Patent Application No. 605/CHE/2010, filed Mar. 8, 2010, titled “Manufacturing Blog”, which is incorporated herein by reference in its entirety.

### FIELD

The field generally relates to weblogs and more specifically to weblogs related to supply chain management.

### BACKGROUND

Supply chain processes these days are highly automated. For instance, a shop floor has several sensors to monitor every event in the plant and the data is captured and stored in internal systems. In places where the shop floor is not automated, the data from the production line is captured manually at every stage. Detailed information is also captured as a part of compliance requirements in several industries. Genealogy information captured for compliance purposes is also valuable during failures or product recalls. Companies store the data in large repositories. The data may be saved for several years. However, such data is saved typically for the company's own purposes and is not shared with the outside world.

In the modern world, decisions to buy a product may be based on the manufacturer, location of the manufactured product, manufacturing date, elements of the product and so on. Consumers may be concerned about the impact of the manufacturing process on the environment. For instance, a young mother buying an apparel for her infant may make her decision based not only on the design and price, but also on facts such as, whether any harmful chemicals were used on the fabric, and whether child labor was used to make the apparel and whether the manufacturer is flooding the environment with harmful effluents. Therefore, there may be a need for consumers to have access to such information via supply chain management related information sources to understand more about the way products are manufactured.

### SUMMARY

Various embodiments of systems and methods for a weblog for supply chain management are described herein. The method and systems involve receiving data from one or more machines associated with a supply chain process, the supply chain process comprising a plurality of data publishing stages, updating the weblog with the data received from each data publishing stage of the one or more machines, retrieving access rights for accessing the data updated to the weblog and displaying the data in the weblog based on the access rights.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments, together with their advantages, may be best understood from the following detailed description taken in conjunction with the accompanying drawings.

FIG. 1 is a block diagram illustrating an exemplary method for implementing supply chain management weblog according to an embodiment.

FIG. 2 is a flow diagram illustrating an exemplary method for accessing each stage of a supply chain process through a weblog according to an embodiment.

FIG. 3 is a block diagram of a business scenario for tracking each stage of a supply chain process through a weblog according to an embodiment.

FIG. 4 is a block diagram of a business scenario for machines to blog according to an embodiment.

FIG. 5 is a block diagram of a business scenario for accessing the weblog according to an embodiment.

FIG. 6 is a block diagram of an exemplary system for accessing a supply chain process through a weblog according to an embodiment.

FIG. 7 is a block diagram of an exemplary computer system according an embodiment.

### DETAILED DESCRIPTION

Embodiments of techniques for weblog for supply chain management are described herein. In the following description, numerous specific details are set forth to provide a thorough understanding of various embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

A supply chain management includes various stages. The various stages may be, but are not limited to, logistics operations stage, manufacturing stage, packing stage, shipment stage and so on. Data may be captured at each stage of the supply chain. For instance, the logistics operations stage may include the manufacturer collecting required components for manufacturing a product. Collecting the required components may include the process of accepting a shipment for the components, entering receipt details of the shipment, issuing the components for manufacturing process. The manufacturing stage may further include many sub manufacturing stages. Once the product is manufactured, the product may be shipped to the customer. The shipment stage may include shipping details and the receipt of the manufactured product. The data captured at each stage of the supply chain management may be updated to a weblog. The data may be captured based on a tag printed on the product. In one embodiment, the tag may be a barcode.

The weblog is an online journal that may be updated when an event occurs in the real world or when a blogger wants to share some information. The weblog is typically documented in a chronological order. The weblog may be shared within a closed community or publicly. The community may be formed when the weblog becomes a platform for discussion among the readers and writers of the weblog. In one embodiment, machines update the weblog according to settings in a control system. The machine blogs may be linked to trace the origin of the supply chain management. Various blogs may be linked together to form a machine blog. The data posted on the machine blog may be used by consumers to make decisions to buy a particular product. The data posted on the weblog may be used by several users in different parts of the supply chain in multiple ways. The data shared in the weblog may be accessed by the users according to the access rights defined by an administrator. The access rights may include disclosure levels which may allow or restrict the users from accessing few portions of the data shared in the weblog.

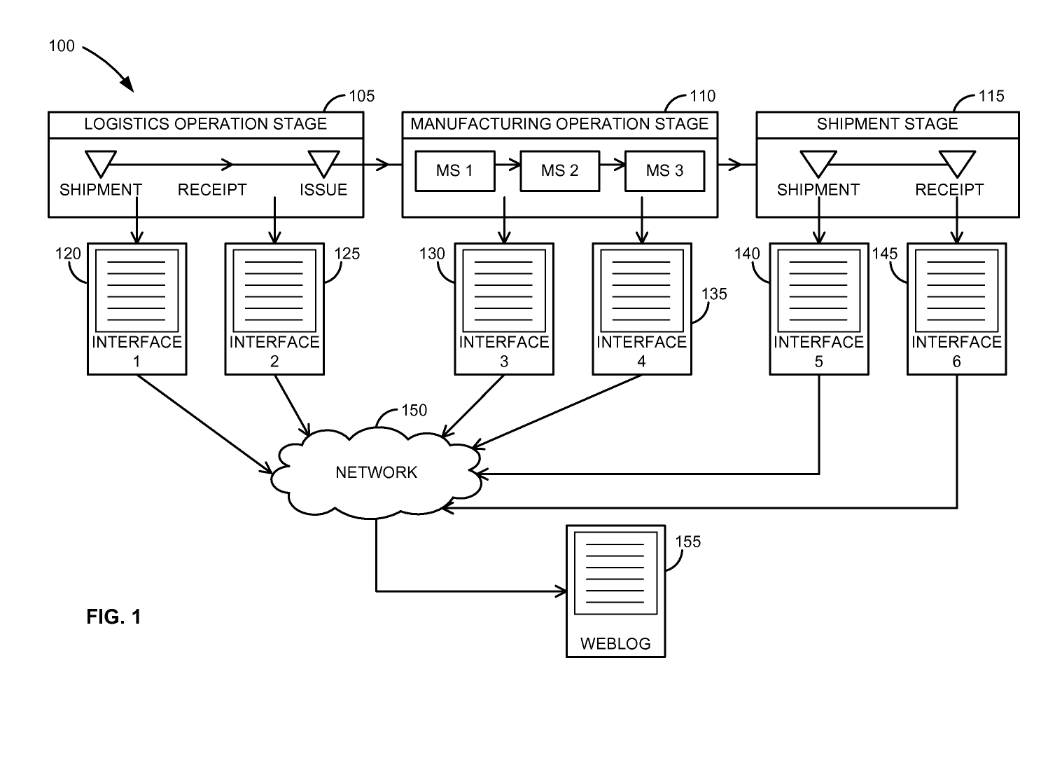

FIG. 1 is a block diagram illustrating an exemplary method for implementing supply chain management weblog according to an embodiment. Business scenario 100 includes a supply chain process including a logistics operation stage 105, a manufacturing operation stage 110 and a shipment stage 115. The logistics operation stage 105 may include receiving a shipment of required components at a warehouse for manufacturing a product, entering the receipt of the components to a register, issuing the required components to a manufacturing operation unit to manufacture the required product. Data captured at each stage of the logistics operation stage 105 is updated into a weblog 155. In one embodiment, each stage of the logistics operation stage 105 may be updated to a weblog server. In one embodiment, a machine updates the weblog according to control system settings. For instance, an event may be triggered when a data entry operator enters the receipt of a component into an inventory management system. The inventory management system may maintain details about the receipt and delivery of the component. The data received upon the event trigger may be updated to the weblog 155. The control system settings may include instructions to receive data from the machine at specific intervals of time. The second stage is the manufacturing operation stage 110 where the product may be developed at three manufacturing stages (MS) such as MS1, MS2 and MS3. Selected changes in the manufacturing operation stage 110 are updated to the weblog 155. After completing the manufacturing operation stage 110, the process proceeds to shipment stage 115. At the shipment stage 115, data may be captured at the warehouse when entering the receipt of the product for shipment. The data captured at the logistics operation stage 105, manufacturing operation stage 110 and the shipment stage 115 are updated through their respective interfaces 120, 125, 130, 135, 140 and 145. In one embodiment, each stage of the supply chain process may have an interface associated with an initial stage and a final stage. For instance, the logistics operation stage 105 may include an interface 120 at an initial stage of the logistics operation stage 105 and another interface 125 at a final stage of the logistics operation stage 105. The interfaces 120, 125, 130, 135, 140 and 145 may be associated with a data input device such as computer. The data may be updated to the weblog 155 through a network 150.

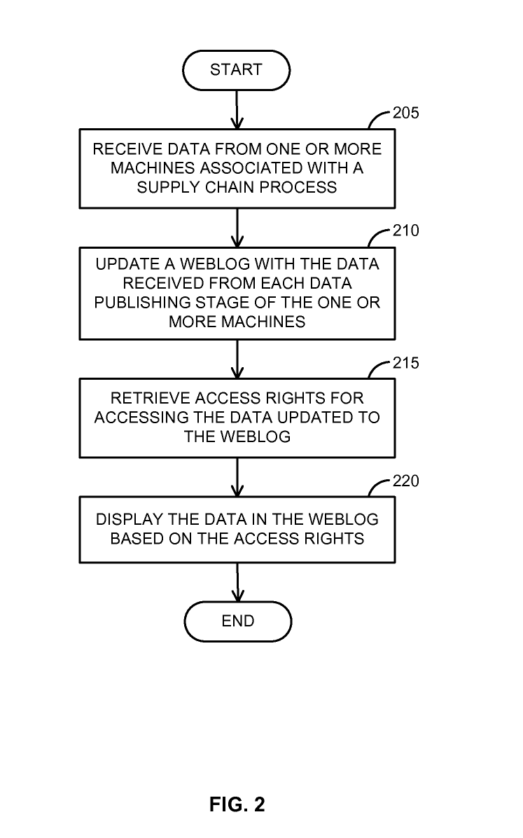

FIG. 2 is a flow diagram illustrating an exemplary method for accessing each stage of a supply chain process through a weblog according to an embodiment. At process block 205, data is received from one or more machines associated with the supply chain process. The supply chain process may include a plurality of data publishing stages. The publishing stage includes a machine for publishing data at regular intervals to the blog. According to one embodiment, the data may be published based on an event trigger in a machine. In one embodiment, the machine is registered to become eligible for publishing data. The registered machine initiates a session for the machine to publish data. The registered machine may publish data when an event is triggered. At process block 210, a weblog is updated with the data received from each data publishing stage of the one or more machines. The received data is updated in a weblog format. The weblog format may be a layout according to which the data in the weblog is arranged. The format may include but is not restricted to syntax, syndication format, and archiving format. The captured data may be updated to the weblog through a write interface. The write interface may include but is not restricted to computers and mobile devices. At process block 215, access rights are retrieved for accessing the data updated to the weblog. In one embodiment, the access rights may be retrieved from a security access module. The access rights may include disclosure levels for accessing the weblog. The disclosure levels for accessing the weblog may include allowing or restricting a user to view a specific content of the weblog. For instance, a consumer may be able to view the components in the product whereas he will not be able to view the percentage contribution of the components to manufacture the product. At process block 220, the data in the weblog is displayed based on the access rights. The weblog may be displayed on a user interface of a computing device.

In one embodiment, the machine may be a computer which may be updated upon selected changes in the supply chain process stages. In another embodiment, registering the machine to update the weblog may involve the process of configuring a control system to acquire data from the machine at regular intervals. A control system may monitor the machine for specific activities as specified by a user. The control system may include but is not limited to distributed control system (DCS), and supervisory control and data acquisition (SCADA).

In another embodiment, the weblog enables the user to trace the supply chain management process. In order to trace the supply chain management process, the user may use a unique serial number or a batch number printed on the product. The user may use the unique serial number or the batch number of the product to retrieve the supply chain management process associated with the product. In order to retrieve the supply chain management process, the blog may be hosted on a central resource in the network.

In yet another embodiment, the contents in the weblog may be categorized according to each discrete activity of the supply chain management such as storage, inspection, manufacture, shipment and so on. An author of the weblog may specify the type of activity and update the captured data accordingly.

In yet another embodiment, the author of the weblog may decide the disclosure levels. The author may decide to disclose general steps of the supply chain management such as logistics operation, manufacturing operation stage and shipment.

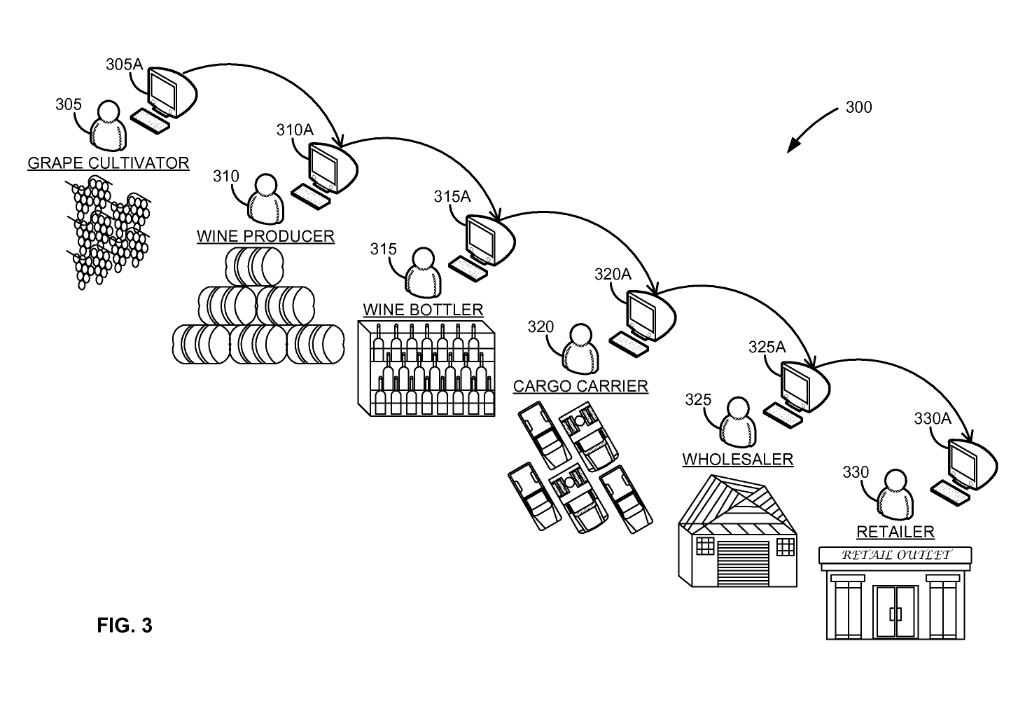

FIG. 3 is a block diagram of a business scenario for tracking each stage of a supply chain process through a weblog according to an embodiment. Consider the business scenario 300 of a wine supply chain. At a first stage, a machine 305A at a grape cultivator 305 may blog the details about the grape cultivation. The details may include the climate in which the grapes were cultivated. For example, a thermostat could publish the temperature and an electronic barometer could publish the precipitation levels at the growing location. Likewise pesticides and fertilizers used for the cultivation along with the batch numbers could be published by the machines associated with these activities. The machine 305A updates the details about the grape cultivation on an event trigger. The event may be triggered when a machine enters details about the grape cultivation. The second stage involves a machine 310A at a wine producer 310 blogging the location from where the grapes were harvested along with the batch numbers, the process followed to produce wine. The process followed to produce wine may include but may not be restricted to processing the grapes, fermenting the grape extract and filtering the grape solution. The machine 310A updates the process followed to produce wine to the weblog. The third stage involves a wine bottler 315 having a machine 315A blogging about the packaging records. The packaging records may include but are not restricted to packaging details such as the temperature under which the wine is packaged, the type of containers in which the wine is packaged. The machine 315A at the wine bottler 315 may also blog about his adherence to compliance of environmental laws. A fourth stage involves a machine 320A at a cargo carrier 320 blogging about the content of each delivery, the carrier used and the adherence to export law. The fifth stage involves a machine 325A at a wholesaler 325 blogging about the imports. The machine 325A at the wholesaler 325 may also blog about adherence to local labor laws and environmental conditions offered for wine storage. The sixth stage involves a machine 330A at a retailer 330 blogging the batch numbers of the wine containers he gets from the wholesaler 325.

The six stages of the wine supply chain process may be updated into a weblog server through a network. The weblog server updates the weblog accordingly. In one embodiment, the six stages of the wine supply chain may occur across different geographical locations. The weblog may be used by various users for different purposes. For instance, if a customer who purchased the wine has complaints about the quality of the wine, he may trace the wine supply chain to determine where the quality may have been compromised. The customer may trace the wine supply chain weblog by entering the unique serial number or a batch number. Once the customer enters the batch number, the entire wine supply chain stages is displayed to the user. The customer may identify one stage of the wine supply chain which is not satisfying the required standards. In this business scenario, the third stage of the wine supply chain (i.e., wine bottler stage) may not be satisfying the required standards. In such case, a concerned government body may take necessary actions to withdraw the sales of the wines that were bottled at that stage. The sales of the wines may be withdrawn according to the batch numbers on the wine bottle.

In another instance, the customer may comment about the quality of the wine in the comment section of the weblog. The concerned department of the winery may identify the wine supply chain which is not satisfying the required standards.

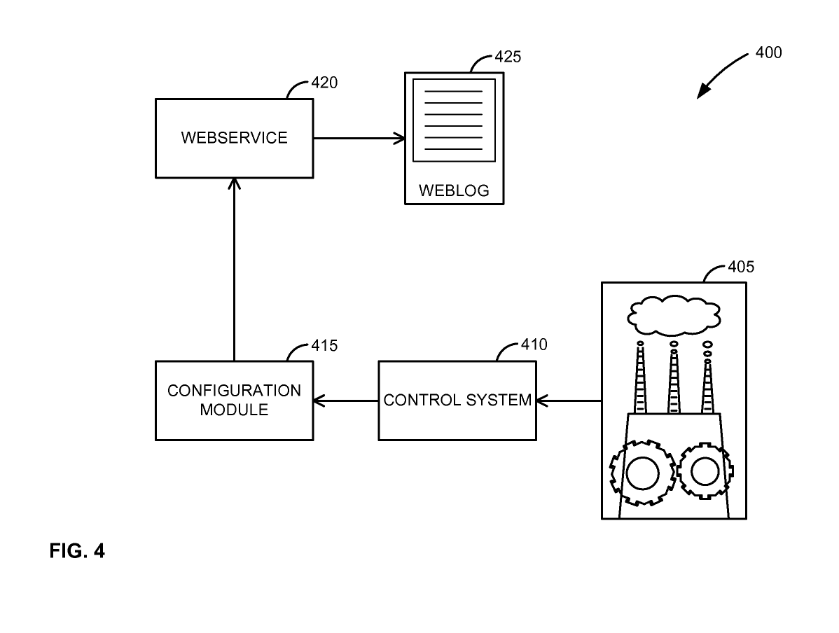

FIG. 4 is a block diagram of a business scenario for machines to blog according to an embodiment. Consider a business scenario 400 of a pollution monitoring system. The pollution may be monitored at a gas analyzer 405. The gas analyzer 405 may include a sensor which updates a control system 410. The control system 410 may include but not be limited to DCS and SCADA. The control system 410 manages the activities of the gas analyzer 405 by maintaining data associated with the gas analyzer 405 such as temperature, pressure, carbon levels and so on. The data for the gas analyzer 405 may be acquired from the sensors of the gas analyzer 405. The data from the control system 410 is updated to a configuration module 415. In the configuration module 415, the user may specify specific fields of data which may be updated from the control system 410. In the business scenario 400, the fields specified by the user may include a reading minimum and maximum temperature of the gas analyzer, reading minimum and maximum carbon levels of the gas analyzer, computing minimum and maximum carbon levels in the gas analyzer. These specific fields of data are updated to the weblog 425 through a web service 420. The web service 420 converts the data in the configuration module 415 into a web application, which may publish the data to the weblog 425. The weblog 425 is updated with the gas analyzer data at regular intervals.

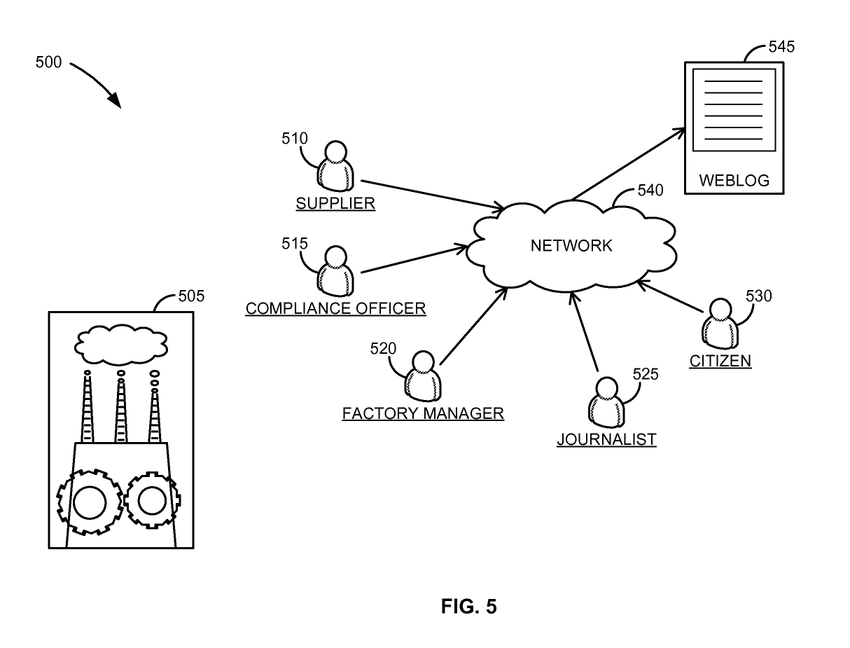

FIG. 5 is a block diagram of a business scenario for accessing the weblog according to an embodiment. Various users such as a supplier 510, a compliance officer 515, a factory manager 520, a journalist 525, a citizen 530, and a customer may subscribe to the weblog 545. On subscribing to the weblog 545, access is granted to the users. The weblog 545 may be followed by users across various geographical locations through a network 540. Weblog 545 provides a common platform to users to exchange each other's views on a topic of discussion.

Consider a business scenario 500 of the weblog 545 associated with a factory violating the environmental laws. In this scenario, the factory may be emitting hazardous carbon content which exceeds the limit specified by the environmental law. The weblog 545 associated with the factory may be traced to check where the problem lies. The weblog 545 may include comments from the citizens about the factory emitting hazardous smoke to the environment. Various users accessing the weblog 545 may take an action. For instance, a citizen 530 facing environmental problem due to a factory may comment on the weblog 545, a journalist 525 who is keen on this topic may publish an article which may prompt the compliance officer 515 to take an action on the problem. The comments received on the weblog 545 may trigger an event to the factory management to take action against the problem. A factory manager 520 at the factory management may trace the problem to the supplier 510 who may have sent some defective component causing the hazardous smoke to the environment.

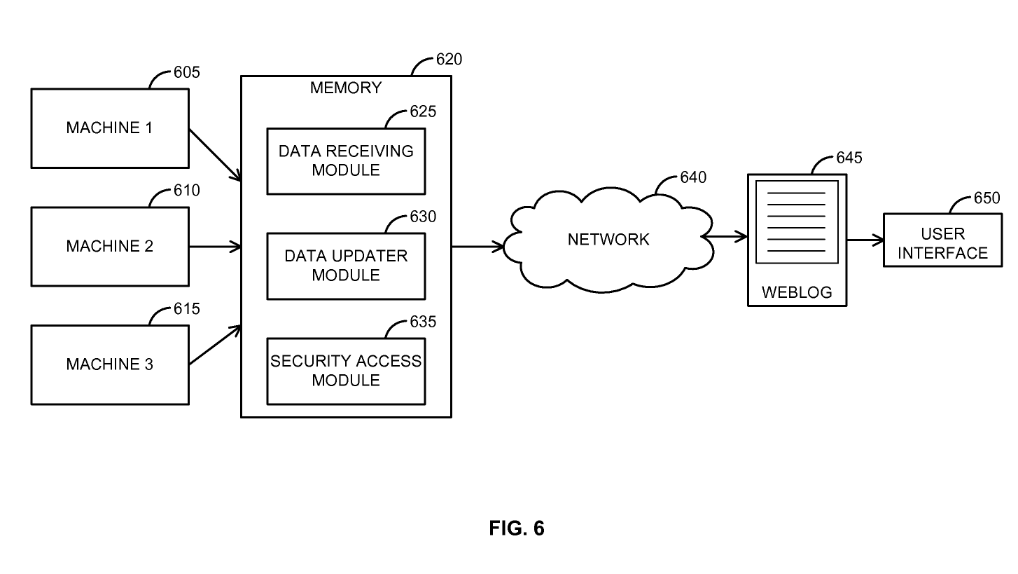

FIG. 6 is a block diagram of an exemplary system for accessing a supply chain process through a weblog according to an embodiment. The computer system includes machine 1 605, machine 2 610, machine 3 615, a memory 620, a network 640, a weblog 645 and a user interface 650. The memory 620 further includes a data receiving module 625, data updater module 630 and a security access module 635. A processor (not shown), in communication with the memory 620 includes instructions for the data receiving module 625, data updater module 630 and a security access module 635 to perform the required operations.

The machine 1 605, machine 2 610 and machine 3 615 publish data associated with a supply chain process comprising a plurality of data publishing stages. A data receiving module 625 receives data from the each of the data publishing stages of machine 1 605, machine 2 610 and machine 3 615. The data received at each data publishing stage is updated to the weblog 645 by a data updater module 630 through a network 640. The data is updated in the format of the weblog 645. The data may be received when an event is triggered by a change in the machine.

The security access module 635 stores access rights to view the data updated in the weblog 645. The access rights may be defined by an administrator. The access rights may be categorized according to a role of the user. The role of the user may be citizen, customer, supplier, journalist and so on. According to the role of the user, the access rights include disclosure levels. The disclosure level allows or restricts the user to view a specific content of the weblog 645. The user interface 650 displays the data received from the machine 1 605, machine 2 610 and machine 3 615 according to the access rights. In one embodiment, the data updater module 630 registers a machine associated with the supply chain process to update the weblog 645. Registering the machine to update the weblog may involve the process of configuring a control system to acquire data from the machine at regular intervals.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer-readable media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

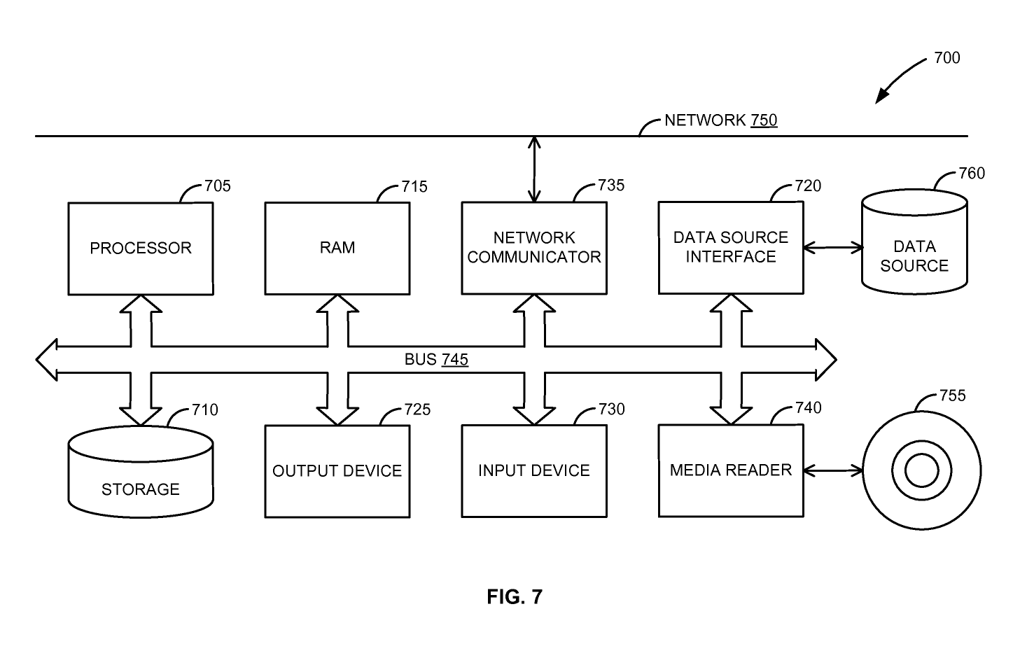

FIG. 7 is a block diagram of an exemplary computer system 700 according to an embodiment. The computer system 700 includes a processor 705 that executes software instructions or code stored on a computer readable storage medium 755 to perform the above-illustrated methods of the invention. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment of the invention, the computer system 700 further includes an output device 725 (e.g., a display) to provide at least some of the results of the execution as output including, but not limited to, visual information to users and an input device 730 to provide a user or another device with means for entering data and/or otherwise interacting with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however, that the invention can be practiced without one or more of the specific details or with other methods, components, techniques, etc. In other instances, well-known operations or structures are not shown or described in detail to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
receive data from one or more machines associated with a supply chain process, the supply chain process comprising a plurality of data publishing stages;
update a weblog with the data received from each data publishing stage of the one or more machines;
retrieve access rights for accessing the data updated to the weblog; and
based on the access rights, display the data in the weblog.

2. The article of manufacture in claim 1, wherein receiving the data from the one or more machines comprises receiving the data from a one or more registered machines.

3. The article of manufacture in claim 2, wherein the one or more registered machines comprises at least one registered machine initiating a session for the registered machine to update the weblog.

4. The article of manufacture in claim 1, wherein receiving the data from the one or more machines comprises receiving the data based on an event trigger.

5. The article of manufacture in claim 1, wherein updating the weblog with the data received from each data publishing stage comprises updating the received data in a weblog format.

6. The article of manufacture in claim 1, wherein retrieving the access rights comprises retrieving disclosure levels for accessing the weblog.

7. The article of manufacture in claim 6, wherein retrieving the disclosure levels comprises the disclosure levels for allowing the user to view specific content of the weblog.

8. The article of manufacture in claim 6, wherein retrieving the disclosure levels comprises the disclosure levels for restricting the user to view specific content of the weblog.

9. A computer system for accessing a supply chain process through a weblog, the computer system comprising:
a one or more machines for publishing data associated with the supply chain process, the supply chain process comprising a plurality of data publishing stages;
a processor;
a memory in communication with the processor for storing:
a data receiving module to receive data from each data publishing stage of the supply chain process;
a data updater module for updating the data received at each data publishing stage of the supply chain process to the weblog;
a security access module to store access rights for accessing the data updated weblog; and
a user interface for displaying the data received from the one or more machines according to the access rights.

10. The computer system of claim 9, wherein the data updater module updates the data received from each of the data publishing stages according to a weblog format.

11. The computer system of claim 9, wherein the data updater module registers one or more machines associated with the supply chain process to update the weblog.

12. The computer system of claim 9, wherein the security access module stores disclosure levels associated with the weblog.

13. A computerized method for accessing a supply chain process through a weblog, the computer system comprising:
receiving data from one or more machines associated with the supply chain process, the supply chain process comprising a plurality of data publishing stages;
updating the weblog with the data received from each data publishing stage of the one or more machines;
retrieving access rights for accessing the data updated to the weblog; and
based on the access rights, displaying the data in the weblog.

14. The computerized method of claim 13, wherein receiving the data from the one or more machines comprises receiving the data from a one or more registered machines.

15. The computerized method of claim 14, wherein the one or more registered machines comprises initiating a session for the machine to update the weblog.

16. The computerized method of claim 14, wherein receiving the data from the one or more machines comprises receiving the data based on an event trigger in the machine.

17. The computerized method of claim 14, wherein updating the weblog with the data received from each data publishing stage comprises updating the received data in a weblog format.

18. The computerized method of claim 13, wherein retrieving access rights comprises retrieving disclosure levels for accessing the weblog.

19. The computerized method of claim 18, wherein retrieving the disclosure levels comprises the disclosure levels for allowing the user to view specific content of the weblog.

20. The computerized method of claim 18, wherein retrieving the disclosure levels comprises the disclosure levels for restricting the user to view specific content of the weblog.
